(19) United States
(12) Patent Application Publication
(10) Pub. No.: US 2012/0204056 A1
(43) Pub. Date: Aug. 9, 2012

(54) Power Signature Obfuscation

(76) Inventors: Cedric Denis Robert Airaud, Saint Laurent Du Var (FR); Jean-Baptiste Brelot, Antibes (FR); Stephane Zonza, Cannes (FR)

(21) Appl. No.: 13/317,600

(22) Filed: Oct. 24, 2011

(30) Foreign Application Priority Data
Feb. 3, 2011 (GB) 1101834.8

(51) Int. Cl. G06F 1/12

(52) U.S. Cl. 713/401

(57) ABSTRACT

A data processing apparatus is configured to perform a data processing operation on at least one data value in response to a data processing instruction. The data processing apparatus comprises a delay unit situated on a path within the data processing apparatus, wherein the delay unit is configured to apply a delay to propagation of a signal on the path and propagation of that signal forms part of the data processing operation. The data processing apparatus is configured to determine a result of the data processing operation at a predetermined time point, wherein the predetermined time point following an initiation of the data processing operation by a predetermined time interval. The delay unit is configured such that a time for the data processing operation to be performed plus the delay is less than the predetermined time interval.

### FIELD OF THE INVENTION

The present invention relates to data processing apparatuses for which it is sought to hide their internal operations from an external observer. In particular, the present invention relates to arranging such a data processing apparatus such that it is difficult for an external observer to deduce the data processing operations it is performing by observing the power consumption of the data processing apparatus.

### BACKGROUND OF THE INVENTION

It is known to provide data processing apparatuses in which measures are taken to hide the data processing operations carried out from an external observer. For example, a data processing apparatus such as that in a smart card is typically configured in such a way as to make power analysis attacks (either SPA or DPA) less likely to be successful. The aim of such power analysis attacks is to deduce information about the instructions being executed by the data processing apparatus and/or the data values being handled by the data processing apparatus by observing the power consumption of the data processing apparatus. It is known that such contemporary power analysis attacks can be sophisticated, involving repeated observations of the data processing apparatus in response to the given stimuli and performing complex statistical analyses of the results to seek to deduce information about the data processing operations being carried out. The data values being handled by the data processing apparatus are often the most sought after information, since these may relate to sensitive information which is otherwise encrypted, for example personal or financial information stored on a smart card.

One approach to defending against power analysis attacks is to try to ensure that the data processing apparatus has a uniform power consumption regardless of the particular data processing operations being carried out. However, in practice this is very difficult to achieve since the power consumption will depend on the type of instruction being executed and on the data values being handled.

An alternative approach to defending against such attacks is to arrange the data processing apparatus such that its power consumption is different each time the same data processing operation (i.e. for the same instruction and the same data values) is carried out. Various techniques in the implementation of such data processing apparatuses are known for varying the power consumption in this way, however, these techniques are often imposed at a relatively high level (from an architectural point of view), for example programmed as part of an algorithm which the data processing apparatus is executing. This means that the technician setting up such a device must be aware of the implications of each aspect of the implementation of the data processing apparatus for its vulnerability to power analysis attack.

Accordingly, it would be desirable to provide a data processing apparatus wherein its resistance to power analysis attack is a inherent feature of its architecture, thus making its resistance to such attacks more reliable.

### SUMMARY OF THE INVENTION

Viewed from a first aspect, the present invention provides a data processing apparatus configured to perform a data processing operation on at least one data value in response to a data processing instruction, said data processing apparatus comprising: a delay unit situated on a path within said data processing apparatus, said delay unit configured to apply a delay to propagation of a signal on said path, wherein propagation of said signal on said path forms part of said data processing operation, wherein said data processing apparatus is configured to determine a result of said data processing operation at a predetermined time point, said predetermined time point following an initiation of said data processing operation by a predetermined time interval, and wherein said delay unit is configured such that a time for said data processing operation to be performed plus said delay is less than said predetermined time interval, and wherein said delay unit is configured such that said delay is changed for a subsequent performance of said data processing operation on said at least one data value in response to said data processing instruction.

According to the techniques of the present invention, a path within the data processing apparatus is provided with a delay unit which is configured to delay a signal which propagates along that path, the propagation of this signal along the path forming part of a data processing operation on a data value in response to a data processing instruction. It should be understood that a data processing instruction here may be understood as an instruction forming part of a sequence of program instructions (e.g. written in assembler language), but could equally, say, represent a set of control values provided by a state machine (for example in a hard-wired crypto-engine).

The data processing apparatus is configured to determine a result of the data processing operation at a predetermined time point (for example on a falling clock edge) which follows the initiation of the data processing operation by a predetermined time interval (for example the data processing operation being initiated by a rising clock edge and the time interval being the time period between that rising clock edge and the next falling clock edge). The delay unit is configured to apply a delay on the path such that the time for the data processing operation to be performed plus the delay is less than this predetermined time interval. For example, where the data processing operation is the addition of two data values, and an adder within the data processing apparatus is configured to begin that adding operation after a rising clock edge, the data processing apparatus is configured to determine the result value as that value present at the adder output on the subsequent falling clock edge. In this example situation, the delay unit is configured to apply a delay on the path, such that the combination of the time required to perform the adding operation and the imposed delay does not exceed the interval between the clock edges, and hence the output of the adder is unaffected by the introduction of the delay.

The delay unit is further configured such that when the same data processing operation is performed again, initiated by the same data processing instruction and operating on the same data value, the delay is changed.

During the predetermined time interval when the data processing apparatus performs the data processing operation, the power consumption of the data processing apparatus will typically be affected by both the particular data processing operation being carried out and the data value(s) on which that operation is being performed. Power analysis attacks rely on this fact and may be able to deduce information about the operation and/or the data values by gathering statistical data based on repeated observations. However, according to the technique of the present invention, the application of a delay to one of the paths used in the data processing operation will cause the power consumption associated with the data processing operation to change. This is because the data processing operation is configured by a particular set of signals within the data processing apparatus which specify both the operation to be carried out and the data value(s) which are subject to that data processing operation. If a delay is applied to a path carrying one of those signals, then the internal state of the data processing apparatus will change when the delay elapses and the delayed signal reaches its destination. The change in internal state of the data processing apparatus will be reflected by a change in its power consumption and hence the introduction of the delay will affect the time profile of the power consumption.

Furthermore, the data processing apparatus according to the present invention is configured such that the delay unit applies a different delay for a subsequent performance of the same data processing operation and hence the power consumption characteristic of the first performance of a data processing operation will differ from the power consumption of subsequent performances of that data processing operation. Hence, even though the input stimuli to the system remain the same, the internal configuration of the data processing apparatus is such that the power consumption of each performance of the data processing operation will be different, thus rendering a power analysis attack more difficult.

Hence, according to the technique of the present invention, a delay which varies for each performance of a given data processing operation is applied to a particular path within the data processing apparatus, the constraint on the length of the delay being that the sum of the time taken for the data processing operation and the delay should be less than the predetermined time interval, such that when the result of the data processing operation is determined, that result is unaffected by the delay applied to the path. The nature of the predetermined time point and predetermined time interval may differ depending on the type of data processing apparatus. In one embodiment, said data processing apparatus is configured to operate synchronously and said predetermined time interval is a clock interval. Hence, in such a synchronous device, where clock edges form the synchronisation points on each clock cycle, the data processing apparatus may for example be configured to begin the data processing operation following one clock edge and to determine the result of the data processing operation on the occurrence on the next clock edge. Typically one type of clock edge (e.g. the rising edge) is selected to be used. In this situation, the delay applied to the path (wherein propagation of the signal on that path forms part of the data processing operation) is constrained such that the time for the data processing operation to be performed plus the delay is less than the interval between the selected clock edges, such that despite introduction of the delay during the clock interval, the result value determined at the falling clock edge is nevertheless unaffected by the introduction of the delay.

Alternatively, in another embodiment the data processing apparatus is configured to operate asynchronously and said predetermined time interval is an interval between hand-shake events. The same general principle applies in this embodiment, namely that the introduction of the delay on the path causes an additional state change (or at least a variation in when a state change happens) within the data processing apparatus, thus changing the power consumption time profile associated with the performance of the data processing operation. Despite operating asynchronously, such a data processing apparatus nevertheless must have well defined hand-shake events at which the asynchronous components of the apparatus realign themselves and at which a result value can be reliably determined. According to the technique of the present invention, the imposed delay is constrained such that despite the additional delay which is introduced during the interval between hand-shake events, the result value determined at the subsequent hand-shake event is unaffected.

In addition to the above described constraints on the length of the delay, the particular delay applied on any given iteration may be determined in a number of ways. In one embodiment the length of said delay is determined with reference to a random control source. Accordingly, the length of the delay can be randomised, helping to further obfuscate the power consumption associated with the particular data processing operation. The random control source may of course either be provided within the data processing apparatus, or equally the source of this random information may be external to the data processing apparatus.

In another embodiment, a length of said delay is determined by a deterministic algorithm. For example, an algorithm may be provided which causes the delay to change from iteration to iteration in some complex, but nevertheless deterministic, manner which is nonetheless sufficient to further obfuscate the power consumption associated with the data processing operation.

Whilst there may only be one delay unit situated on one path within the data processing apparatus, in some embodiments said data processing apparatus comprises at least one further delay unit situated on at least one further path within said data processing apparatus, said at least one further delay unit configured to apply a further delay to propagation of a further signal on said at least one further path, wherein propagation of said further signal on said at least one further path forms part of said data processing operation and wherein said further at least one delay unit is configured such that said time for said data processing operation to be performed plus said further delay is less than said predetermined time interval, and wherein said further at least one delay unit is configured such that said further delay is changed for a subsequent performance of said data processing operation.

Accordingly, further paths within the data processing apparatus may be provided with delay units, each configured to operate in the manner described above. The provision of such further delay units means that further state changes within the data processing apparatus can occur within the predetermined time interval, thus further distorting of the time-based power consumption profile of the data processing apparatus associated with execution of the data processing operation. It will be recognised that the more such delay units are provided, the more the power consumption characteristic for the data processing operation will change. Furthermore, given that each such delay unit is configured such that the delay changes for a subsequent performance of the data processing operation, it becomes harder and harder to identify a particular data processing operation based on its power consumption signature.

Furthermore, whilst the multiple delay units of such embodiments could be configured to apply the same delay on each iteration, in one embodiment said delay unit and said at least one further delay unit are configured such that said delay and said further delay differ from one another. Thus some, or even all, of the delay units may have different delays, further adding to the change in power signature for each iteration of the data processing operation.

The path can take a variety of forms. In one embodiment said path is a data path, and said signal represents at least one data bit of said at least one data value. Hence, if the at least one data bit of the at least one data value changes (for example as a new input data value is read into an execution unit), the introduction of the delay on this data path will cause that input value to change twice, with an associated change in the power consumption of the data processing apparatus.

It will be appreciated that the delay could be applied to several data bits and in one embodiment said at least one data value comprises a plurality of data bits and said signal represents said plurality of data bits. Alternatively, the delay could be applied to just one data bit, and in one embodiment said at least one data value comprises a plurality of data bits and said signal represents one data bit of said plurality of data bits.

In other embodiments said path is a control path, and said signal represents a control value arranged to configure said data processing apparatus to perform said data processing operation on said at least one data value. Hence, applying the delay to such a control path will cause a change in the configuration signals of the data processing apparatus during the predetermined time interval, thus causing a change to the power consumption.

The configuration of the data processing apparatus by the control value could occur in a number of ways, but in one embodiment said control value configures an execution unit to perform said data processing operation. For example, the execution unit could be configured to perform a number of known data processing operations (add, multiply, shift, etc.), the particular operation being determined by one or more such control values.

Alternatively, the control value could determine the data value used for the data processing operation, and in one embodiment said at least one data value is retrieved from a data store in dependence on said control value. For example the control value could form part of the addressing in the data store. In one embodiment this data store is a register bank.

In yet another alternative, said path is a clock path, and said signal represents a clock signal, wherein said data processing apparatus is configured to perform said data processing operation with reference to said clock signal. It will be appreciated that the orchestration of the sub-components of the data processing apparatus will depend on the clock signal, and hence by applying the delay to a path in one of those sub-components, the internal coordination of the apparatus will be affected, also changing its power consumption signature.

In some embodiments a system register may be provided to allow programmable configuration of the delay and in one embodiment said delay is determined with reference to a value stored in a system register. In one embodiment said value stored in said system register is set by a further data processing instruction.

Viewed from a second aspect the present invention provides a data processing apparatus configured to perform a data processing operation on at least one data value in response to a data processing instruction, said data processing apparatus comprising: delay means situated on a path within said data processing apparatus, said delay means for applying a delay to propagation of a signal on said path, wherein propagation of said signal on said path forms part of said data processing operation, wherein said data processing apparatus is configured to determine a result of said data processing operation at a predetermined time point, said predetermined time point following an initiation of said data processing operation by a predetermined time interval, and wherein said delay means is configured such that a time for said data processing operation to be performed plus said delay is less than said predetermined time interval, and wherein said delay means is configured such that said delay is changed for a subsequent performance of said data processing operation on said at least one data value in response to said data processing instruction.

Viewed from a third aspect, the present invention provides a method of data processing comprising: performing in a data processing apparatus a data processing operation on at least one data value in response to a data processing instruction; applying a delay to propagation of a signal on a path within said data processing apparatus, wherein propagation of said signal on said path forms part of said data processing operation; determining a result of said data processing operation at a predetermined time point, said predetermined time point following an initiation of said data processing operation by a predetermined time interval, and wherein said step of applying a delay is performed such that a time for said data processing operation to be performed plus said delay is less than said predetermined time interval; and changing said delay for a subsequent performance of said data processing operation on said at least one data value in response to said data processing instruction.

### BRIEF DESCRIPTION OF THE DRAWINGS

The present invention will be described further, by way of example only, with reference to embodiments thereof as illustrated in the accompanying drawings, in which:

FIG. 1A schematically illustrates an overview of a data processing apparatus according to one embodiment;

FIG. 1B illustrates the relative timing of some signals in the apparatus shown in FIG. 1A, and FIG. 1C shows an example associated power consumption signature;

FIG. 2A schematically illustrates a data processing apparatus in accordance with another embodiment;

FIGS. 2B and 2C show the signal timing and power consumption diagrams associated with the FIG. 2A apparatus;

FIGS. 3A and 3B show example embodiments in which delays are applied to control signals;

FIG. 4A schematically illustrates a data processing apparatus according to an embodiment in which delays are applied to clock signals;

FIG. 4B schematically illustrates the configuration of delay units being controlled in dependence on the content of a system register;

FIG. 5B schematically illustrates a series of steps taken by a data processing apparatus in one embodiment; and

FIG. 6 schematically illustrates timings in an asynchronous embodiment.

### DESCRIPTION OF EMBODIMENTS

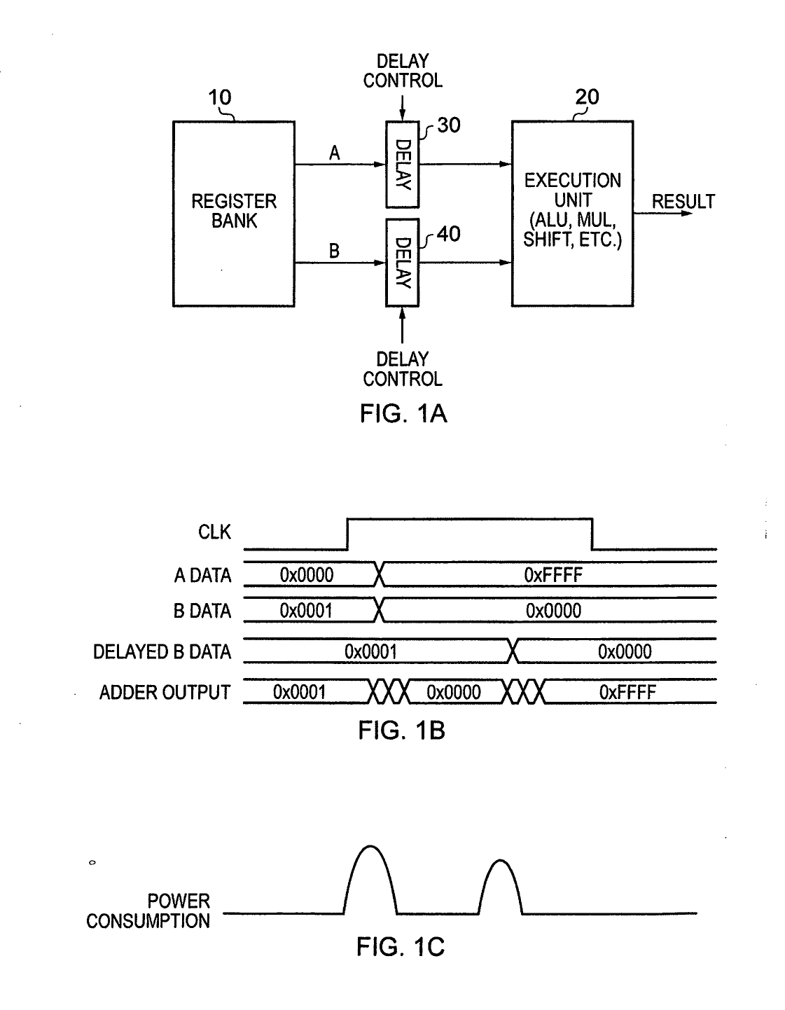

FIG. 1 schematically illustrates a register bank 10 connected to an execution unit 20. The register bank 10 and execution unit 20 form part of a data processing apparatus, further detail of which is omitted for clarity of illustration. The execution unit 20 could be a multi-purpose device configurable to perform a number of different data processing operations, or could be a dedicated data processing device (ALU, multiplier, shifter, etc). The execution unit 20 is configured to receive data values retrieved from the register bank 10 and to perform a data processing operation on those data values to produce a result value. In the illustrated example the paths along which the data values A and B are passed from the register bank 10 to the execution unit 20 are each provided with a delay unit controlled by a delay control (not illustrated). These delay units 30, 40 are configured to apply a delay to their respective path in dependence on the signals they receive from the delay control. The effect of these delay units is illustrated in more detail in the timing diagram shown in FIG. 1B.

FIG. 1B schematically illustrates the relative timings of various signals in a data processing apparatus such as that illustrated in FIG. 1A, when the execution unit 20 is configured as an adder to add the data values A and B together. As can be seen in FIG. 1B, initially the A data being provided to the execution unit is 0x0000 whilst the B data being provided to the execution unit 20 is 0x0001. At this time, the adder output is 0x0001. Following a rising clock edge, the register bank 10 is configured to pass new values of A and B to the execution unit 20, namely 0xFFFF and 0x0000 respectively. However, FIG. 1B schematically illustrates the situation in which a delay is applied to the B path by delay unit 40. In the example illustrated in FIG. 1B no delay is applied on the A path. Hence, whilst following the rising clock edge the A data received by the execution unit 20 soon changes to 0xFFFF, there is a delay until the execution unit receives the new B data 0x0000 on the B path. The result of this is that the adder output first transitions from 0x0001 to 0x0000 and then later, once the delayed B data changes, to 0xFFFF. The two sequences of three back to back transitions in the adder output represent the brief periods in which the adder output (result value) is indeterminate whilst the signals propagate through the adder. These changes in the adder output can be recognised by the associated change in power consumption (see FIG. 1C).

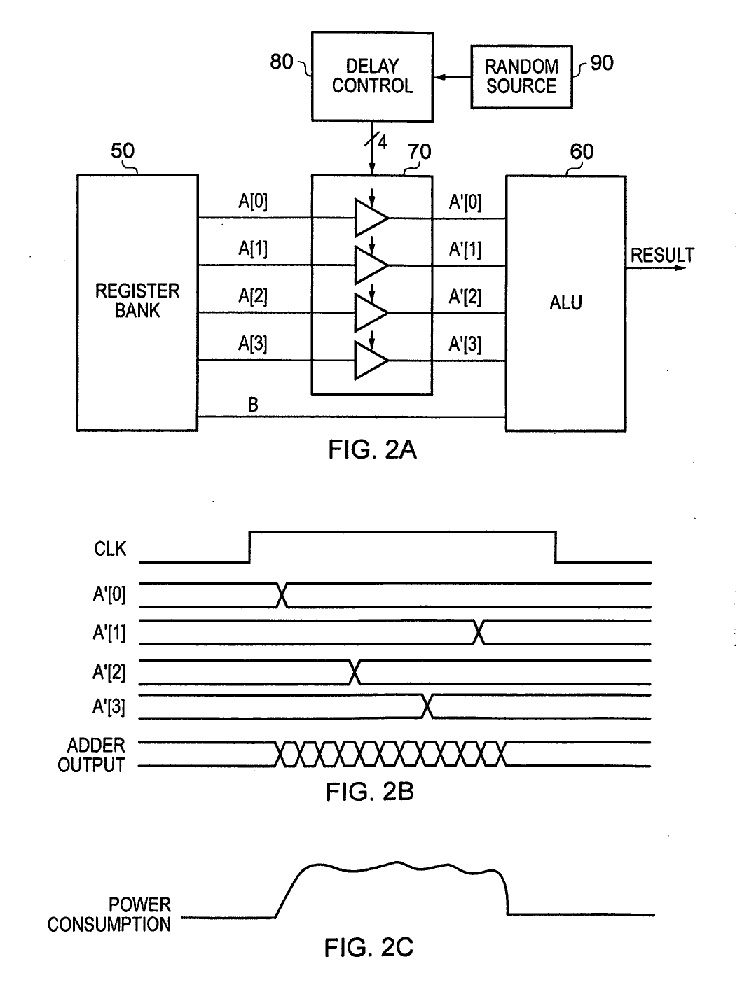

For clarity of illustration, in the example given in FIGS. 1B and 1C, only one delay is globally applied to the B value, and the A value is untouched. A slightly more complex example of applying several delays to several data paths is schematically illustrated in FIGS. 2A-2C. Also, note that in the example illustration of FIG. 1B the relevant clock interval (from initiation of the data processing operation to determination of the result of the data processing operation) is shown as being from a rising clock edge to the following falling clock edge. However another typical implementation uses the same clock edge (e.g. the rising clock edge) to define both the start and the end of the interval.

FIG. 2A schematically illustrates a similar arrangement to that shown in FIG. 1A. Here, a register bank 50 provides data values to ALU 60 which generates a result value in dependence thereon. As illustrated, data values A and B are passed from register bank 50 to ALU 60. The data value A is a four-bit value, each of which are provided on a separate data path. Delay unit 70 sits across these data paths and comprises four individual delay buffers which are controllable to apply an individual delay on each path. Delay unit 70 is controlled by delay control 80 which generates the delays for each of the delay buffers with reference to the random timing source 90.

The effect of the arrangement shown in FIG. 2A is illustrated in the timing diagram of FIG. 2B. Here it can be seen that following the rising clock edge, the four bits of the A data which enter the ALU 60 each arrive at different times. This results from the randomised delay applied to each of the delay buffers within delay unit 70. Overall, the effect of this arrangement on the result value at the adder output is that from the time the first bit of the A data changes (A′[0]), the adder output does not settle into a deterministic state until after the final bit of the A data (A′[1]) has transitioned. Hence, as illustrated in FIG. 2C, there is an ongoing, complex power consumption signature associated with the data operation performed by the ALU 60 on the data values A and B. Furthermore, if the data processing apparatus illustrated in FIG. 2A were to be set up to perform the same data processing operation (i.e. a data processing instruction configures the ALU 60 to perform the same operation on the same input data values), then the observed power consumption of this data processing operation would not be the same, since the randomised delays applied to the delay buffers in delay unit 60 would change, altering the power consumption signature.

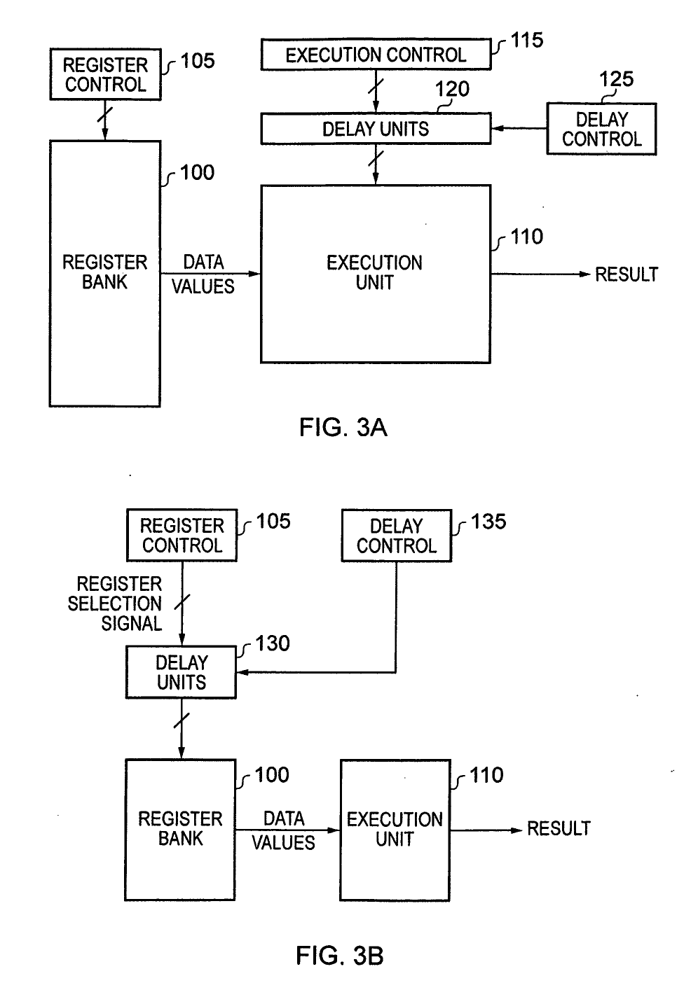

FIG. 3A schematically illustrates how a delay may be applied to a different kind of path. Here, a register bank 100 again provides the input data values to be subjected to a data processing operation by an execution unit 110. The data values selected to be output from the register bank 100 are controlled by register control 105. The execution unit 110 can perform various data processing operations, the particular operation performed at any time being configured by the execution control 115. As illustrated in FIG. 3A, a set of delay units 120 is situated on the path which connects execution control unit 115 to execution unit 110. Delay units 120 are configured to apply delays, configured by delay control 125, to the control signal passing from execution control unit 115 to execution unit 110. Hence, the one or more delays applied by the delay units 120 to the control signal which configures the operation of execution unit 110 will cause execution unit 110 to transition through at least one intermediate configuration state before being set up in the configuration state instructed by the execution control unit 115. Thus even for constant data values inputted to the execution unit 110 (although the data value paths may also be configured as discussed with reference to FIGS. 1A-C and 2A-C), the changing configuration of execution unit 110 will cause the power consumption signature of the data processing apparatus to change, thus obfuscating the true data operation being performed by execution unit 110. Furthermore, even if the execution unit 110 repeats the same data processing operation (same instruction, same input values) the new delays applied by delay units 120 will change the associated power consumption signature.

FIG. 3B schematically illustrates another way in which the delay unit may be applied to a path carrying a control signal in the data processing apparatus. Here, the data values passed from register bank 100 to execution unit 110 are determined by the register control unit 105 using the register selection signal which passes to the register bank 100. As illustrated in FIG. 3B a set of delay units 130 controlled by delay control 135 are situated on the multi-bit register selection signal path between register control 105 and register bank 100. The effect of these delay units is to temporarily alter the register selection signal received by register bank 100. This has the effect that the input values received by the execution 110 change, thus altering the power consumption signal.

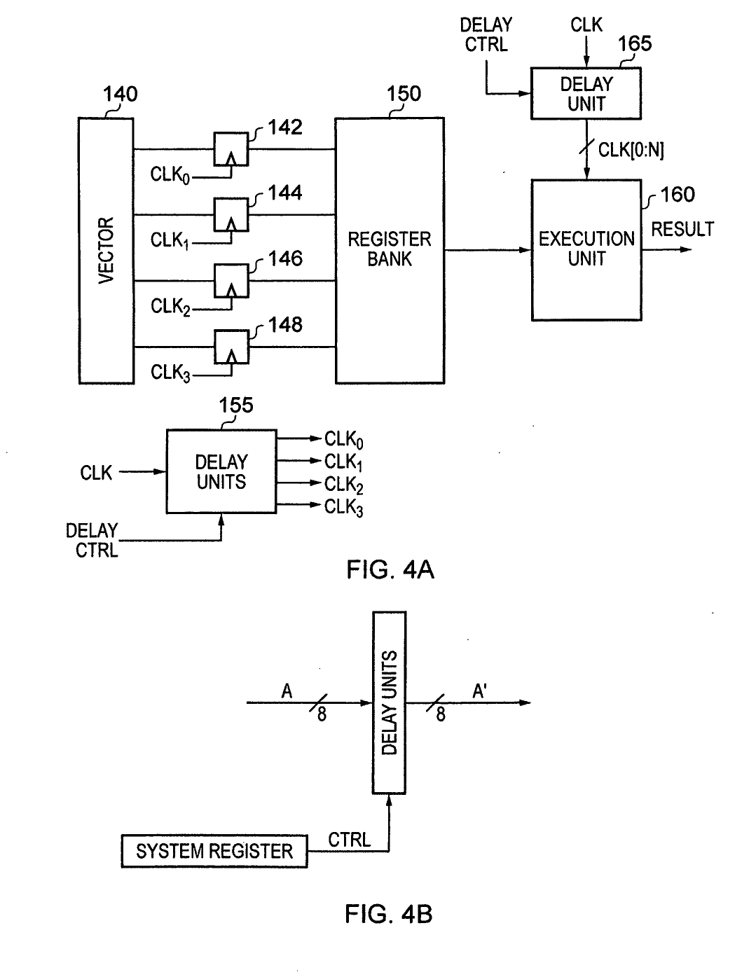

FIG. 4A schematically illustrates a further way in which a delay unit can be applied to a path within the data processing apparatus (which may or may not be combined with the other styles of path delay described above). Here, the path to which the delay is applied carries a clock signal. A first aspect of delaying a clock signal is illustrated on the left of FIG. 4A, wherein a vector 140 is passed into register bank 150. Vector 140 is a four-bit value, each bit being temporarily buffered by a flip-flop 142, 144, 146, 148 en route to register bank 150. The flip-flops 142-148 might normally share a common clock signal, but here a set of delay units 155 generates four clock signals CLK₀₋₃, one for each of the flip-flops. A second aspect of applying the delay to a clock signal is shown in the right-hand part of FIG. 4A wherein execution unit 160 is configured to operate in dependence on the clock signals CLK[0:1N]. These clock signals are generated by delay unit 165 from a single original clock signal CLK. In both examples the provision of different clock signals to different sub-components of the system will again cause a variation in the power consumption signature as described above. Furthermore, the variation in these clock signals will change each time the same data processor operation is carried out, making a power analysis attack considerably more difficult.

The configuration of the delay units in the above described embodiments may be performed by a delay control unit, which in some embodiments may be configured as a system register such that the system programmer can configure aspects of how the delay units operate. FIG. 4B schematically illustrates the control of the delay units on an eight-bit A data signal being controlled in dependence on a system register. Alternatively the delay control unit may be programmed with a deterministic algorithm to vary the delays from iteration to iteration.

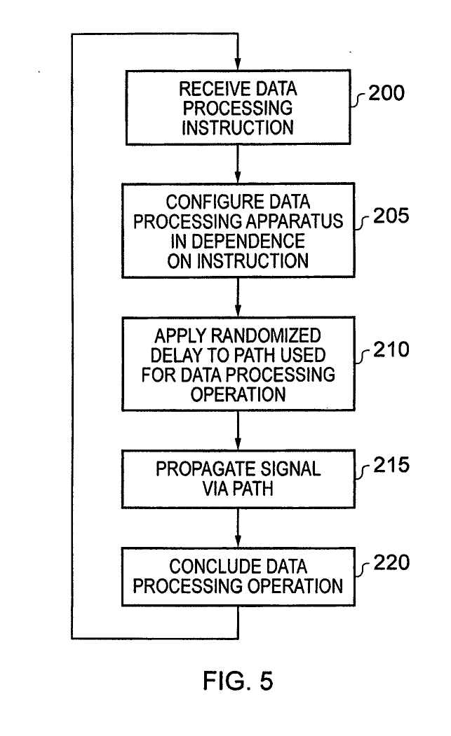

FIG. 5 schematically illustrates a sequence of steps taken in a data processing apparatus according to one embodiment. The flow begins at step 200 where a new data processing instruction is received. At step 205 the data processing apparatus is configured in dependence on the data processing instruction in order to carry out the consequent data processing operation. At step 210 a delay unit on a path which forms part of the data processing apparatus is configured with a randomised delay before at step 215 a signal propagates via the part of the data processing operation. It will be appreciated that steps 205 and 210 could be viewed as taking place simultaneously, or even with step 210 preceding step 205, depending on the particular type of path to which the delay is being applied. The data processing operation concludes at step 220 and the flow returns to step 200. Even if the next data processing instruction is the same and the same data values are to be operated upon, the randomised delay applied to the path (step 210) means that the power consumption resulting from this data processing operation will differ.

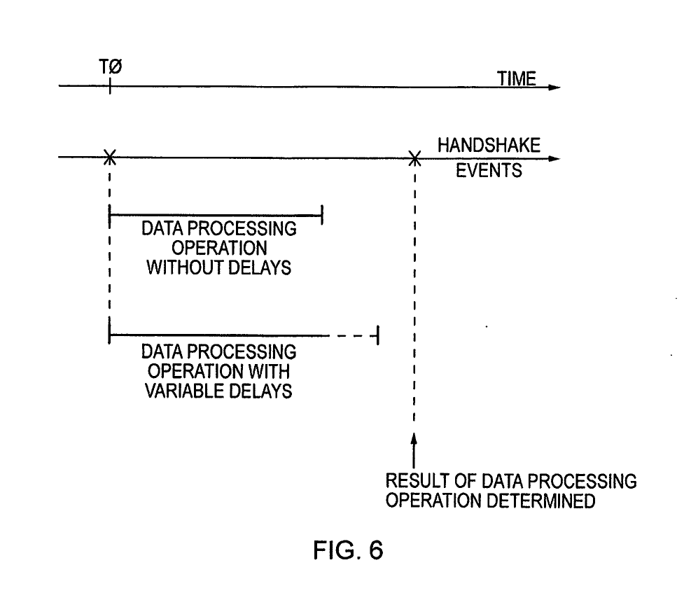

FIG. 6 schematically illustrates the relative timings in an embodiment where the data processing apparatus is an asynchronous device. Hence, the sub-components of the system are free to carry out various aspects of their operations without time constraints between them, with periodic realignment of the sub-components as necessary. The points at which these periodic realignments take place are known as handshake events. Hence, the concept of the present invention is also applicable to such asynchronous devices, wherein a data processing operation begins after a first handshake event, and the result of that data processing operation is only significant at the subsequent handshake event. In the interim, in the same manner as described above in the context of various synchronous embodiments, one or more delays can be applied to one or more paths in the device, to distort the power signature of the device, so long as the application of these delays does not cause extension of the effective data processing period beyond the next handshake event.

Although particular embodiments have been described herein, it will be appreciated that the invention is not limited thereto and that many modifications and additions thereto may be made within the scope of the invention. For example, various combinations of the features of the following dependent claims could be made with the features of the independent claims without departing from the scope of the present invention.

We claim:

1. A data processing apparatus configured to perform a data processing operation on at least one data value in response to a data processing instruction, said data processing apparatus comprising:
a delay unit situated on a path within said data processing apparatus, said delay unit configured to apply a delay to propagation of a signal on said path, wherein propagation of said signal on said path forms part of said data processing operation,
wherein said data processing apparatus is configured to determine a result of said data processing operation at a predetermined time point, said predetermined time point following an initiation of said data processing operation by a predetermined time interval, and wherein said delay unit is configured such that a time for said data processing operation to be performed plus said delay is less than said predetermined time interval, and
wherein said delay unit is configured such that said delay is changed for a subsequent performance of said data processing operation on said at least one data value in response to said data processing instruction.

2. The data processing apparatus as claimed in claim 1, wherein said data processing apparatus is configured to operate synchronously and said predetermined time interval is a clock interval.

3. The data processing apparatus as claimed in claim 1, wherein said data processing apparatus is configured to operate asynchronously and said predetermined time interval is an interval between hand-shake events.

4. The data processing apparatus as claimed in claim 1, wherein a length of said delay is determined with reference to a random control source.

5. The data processing apparatus as claimed in claim 1, wherein a length of said delay is determined by a deterministic algorithm.

6. The data processing apparatus as claimed in claim 1, wherein said data processing apparatus comprises at least one further delay unit situated on at least one further path within said data processing apparatus, said at least one further delay unit configured to apply a further delay to propagation of a further signal on said at least one further path, wherein propagation of said further signal on said at least one further path forms part of said data processing operation,
and wherein said further at least one delay unit is configured such that said time for said data processing operation to be performed plus said further delay is less than said predetermined time interval, and
wherein said further at least one delay unit is configured such that said further delay is changed for a subsequent performance of said data processing operation.

7. The data processing apparatus as claimed in claim 6, wherein said delay unit and said at least one further delay unit are configured such that said delay and said further delay differ from one another.

8. The data processing apparatus as claimed in claim 1, wherein said path is a data path, and said signal represents at least one data bit of said at least one data value.

9. The data processing apparatus as claimed in claim 8, wherein said at least one data value comprises a plurality of data bits and said signal represents said plurality of data bits.

10. The data processing apparatus as claimed in claim 8, wherein said at least one data value comprises a plurality of data bits and said signal represents one data bit of said plurality of data bits.

11. The data processing apparatus as claimed in any of claim 1, wherein said path is a control path, and said signal represents a control value arranged to configure said data processing apparatus to perform said data processing operation on said at least one data value.

12. The data processing apparatus as claimed in claim 11, wherein said control value configures an execution unit to perform said data processing operation.

13. The data processing apparatus as claimed in claim 11, wherein said at least one data value is retrieved from a data store in dependence on said control value.

14. The data processing apparatus as claimed in claim 13, wherein said data store is a register bank.

15. The data processing apparatus as claimed in any of claim 1, wherein said path is a clock path, and said signal represents a clock signal, wherein said data processing apparatus is configured to perform said data processing operation with reference to said clock signal.

16. The data processing apparatus as claimed in claim 1, wherein said delay is determined with reference to a value stored in a system register.

17. The data processing apparatus as claimed in claim 16, wherein said value stored in said system register is set by a further data processing instruction.

18. A data processing apparatus configured to perform a data processing operation on at least one data value in response to a data processing instruction, said data processing apparatus comprising:
delay means situated on a path within said data processing apparatus, said delay means for applying a delay to propagation of a signal on said path, wherein propagation of said signal on said path forms part of said data processing operation,
wherein said data processing apparatus is configured to determine a result of said data processing operation at a predetermined time point, said predetermined time point following an initiation of said data processing operation by a predetermined time interval, and wherein said delay means is configured such that a time for said data processing operation to be performed plus said delay is less than said predetermined time interval, and
wherein said delay means is configured such that said delay is changed for a subsequent performance of said data processing operation on said at least one data value in response to said data processing instruction.

19. A method of data processing comprising:
performing in a data processing apparatus a data processing operation on at least one data value in response to a data processing instruction;
applying a delay to propagation of a signal on a path within said data processing apparatus, wherein propagation of said signal on said path forms part of said data processing operation;
determining a result of said data processing operation at a predetermined time point, said predetermined time point following an initiation of said data processing operation by a predetermined time interval, and wherein said step of applying a delay is performed such that a time for said data processing operation to be performed plus said delay is less than said predetermined time interval; and
changing said delay for a subsequent performance of said data processing operation on said at least one data value in response to said data processing instruction.
